(19) United States
(12) Patent Application Publication
(10) Pub. No.: US 2019/0063036 A1
(43) Pub. Date: Feb. 28, 2019

(54) HAMMER ATTACHMENT

(71) Applicant: Caterpillar Inc., Peoria, IL (US)

(72) Inventor: Karl Steven Kuriger, Raleigh, NC (US)

(73) Assignee: Caterpillar Inc., Peoria, IL (US)

(21) Appl. No.: 15/687,576

(22) Filed: Aug. 28, 2017

(51) Int. Cl. E02F 3/96; E02F 9/22; E02F 9/20; B25D 17/28

(52) U.S. Cl. CPC E02F 3/966; E02F 9/22; B25D 9/00; B25D 17/28; E02F 9/2058

(57) ABSTRACT

A hammer attachment for a machine includes a frame member configured to couple to the machine. The hammer attachment also includes a reciprocating hammer slidably coupled to the frame member such that the hammer is movable along a length of the frame member. Further, the length of the frame member is in a different axis from an axis of reciprocating movement of the hammer.

### TECHNICAL FIELD

The present disclosure relates to a hammer attachment coupled to a machine for performing a hammering operation.

### BACKGROUND

Machines interchangeably receive different work attachments for performing work operations at a worksite. A hammer attachment is used to perform a hammering operation to break ground or rocks, based on requirements. The hammer attachment includes a reciprocating hammer and a frame member to which the reciprocating hammer is attached. The hammer is fixedly attached to the frame member. If a hammering operation is required to be performed at two different locations, the entire machine is moved in order to align the hammer with the desired hammering location. The repositioning and realigning process is time consuming, inaccurate, and laborious in nature, and may sometimes decrease productivity of the hammering operation.

C.N. Patent Number 201470423 describes a crushing hammer for building a furnace and removing bricks in a cement kiln. When in use, the crushing hammer is arranged on an operating mechanism of a small sliding loading machine; and the crushing hammer is provided with a crushing hammer head which is connected with the operating mechanism of the small sliding loading machine by a quick-connecting assembling and welding part, and a connecting structure thereof is a quick-replacement inserted pin type connection structure.

### SUMMARY OF THE DISCLOSURE

In one aspect of the present disclosure, a hammer attachment for a machine is provided. The hammer attachment includes a frame member configured to couple to the machine. The hammer attachment also includes a reciprocating hammer slidably coupled to the frame member such that the hammer is movable along a length of the frame member. Further, the length of the frame member is in a different axis from an axis of reciprocating movement of the hammer.

In another aspect of the present disclosure, a machine is provided. The machine includes a chassis. The machine also includes a linkage assembly. The machine further includes a hammer attachment configured to couple to the linkage assembly. The hammer attachment includes a frame member. The hammer attachment also includes a reciprocating hammer slidably coupled to the frame member such that the hammer is movable along a length of the frame member. Further, the length of the frame member is in a different axis from an axis of reciprocating movement of the hammer.

In yet another aspect of the present disclosure, a method of operating a hammer attachment for a machine is provided. The method includes aligning a reciprocating hammer of the hammer attachment with a first target location. The method also includes performing, by the hammer, a first hammering operation at the first target location. The method further includes moving the hammer along a length of a frame member of the hammer attachment to align the hammer with a second target location. Further, the length of the frame member is in a different axis from an axis of reciprocating movement of the hammer. The method includes performing, by the hammer, a second hammering operation at the second target location based on the movement of the hammer along the length of the frame member.

Other features and aspects of this disclosure will be apparent from the following description and the accompanying drawings.

### BRIEF DESCRIPTION OF THE DRAWINGS

FIG. 1 is a perspective view of an exemplary machine, according to one embodiment of the present disclosure;

FIG. 2 is a perspective view illustrating a front side of a hammer attachment, according to one embodiment of the present disclosure;

FIG. 3 is a perspective view illustrating a rear side of the hammer attachment of FIG. 2; and

FIG. 4 is a flowchart for a method of operating the hammer attachment.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

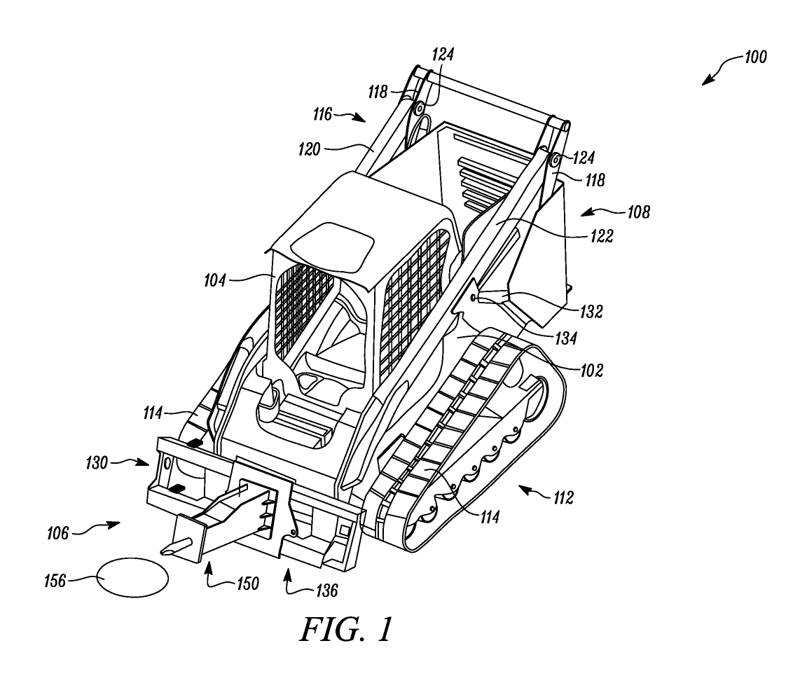

FIG. 1 is a perspective view of a machine 100, according to one embodiment of the present disclosure. In the illustrated embodiment, the machine 100 is embodied as a multi-terrain loader. In alternative embodiments, the machine 100 may include a skid steer loader, a wheel loader, an excavator, a dozer, a harvester, a backhoe loader, or other types of machines known in the art. The machine 100 may perform one or more than one type of operation associated with an industry such as mining, construction, farming, transportation, or any other industry known in the art. The machine 100 may be embodied as a manual, autonomous, or semi-autonomous machine, without any limitations.

The machine 100 includes a chassis 102. An operator cab 104 is mounted on the chassis 102. When the machine 100 is embodied as a manual or semi-autonomous machine, an operator of the machine 100 is seated within the operator cab 104 to perform one or more machine operations. The operator cab 104 includes various input devices, such as joysticks, levers, buttons, knobs, and the like.

Further, the machine 100 defines a front end 106 and a rear end 108. An engine (not shown) is mounted at the rear end 108 of the machine 100 in an engine enclosure (not shown). The engine is generally an internal combustion engine and provides propulsion power to the machine 100 and also powers various components of the machine 100. The machine 100 includes an undercarriage assembly 112. The undercarriage assembly 112 includes tracks 114 that may be driven by a hydraulic system of the machine 100. Alternatively, the machine 100 may include wheels (not shown).

The machine 100 also includes a linkage assembly 116. The linkage assembly 116 may be operated by the hydraulic system of the machine 100. The linkage assembly 116 includes a pair of rear links 118 pivotally connected to respective lift arms 120, 122 at a pivot point 124. A hammer attachment 130 is coupled to the linkage assembly 116. The hammer attachment 130 is adapted to perform a hammering operation at a worksite. The hammer attachment 130 is mounted at the front end 106 of the machine 100 and is coupled to the lift arms 120, 122.

Each of the lift arms 120, 122 is pivotable relative to the chassis 102 to lift the hammer attachment 130, powered by a lift actuator 132. The lift actuator 132 is typically a conventional hydraulic cylinder, a pneumatic cylinder, or other linear acting actuator. The lift actuator 132 is connected at its opposite end to the associated lift arms 120, 122 at pivot point 134. The hammer attachment 130 may be pivoted relative to the lift arms 120, 122 by means of one or more tilt actuators (not shown), which are typically hydraulic, pneumatic, or other linear acting actuators, connected between the lift arms 120, 122 and the hammer attachment 130.

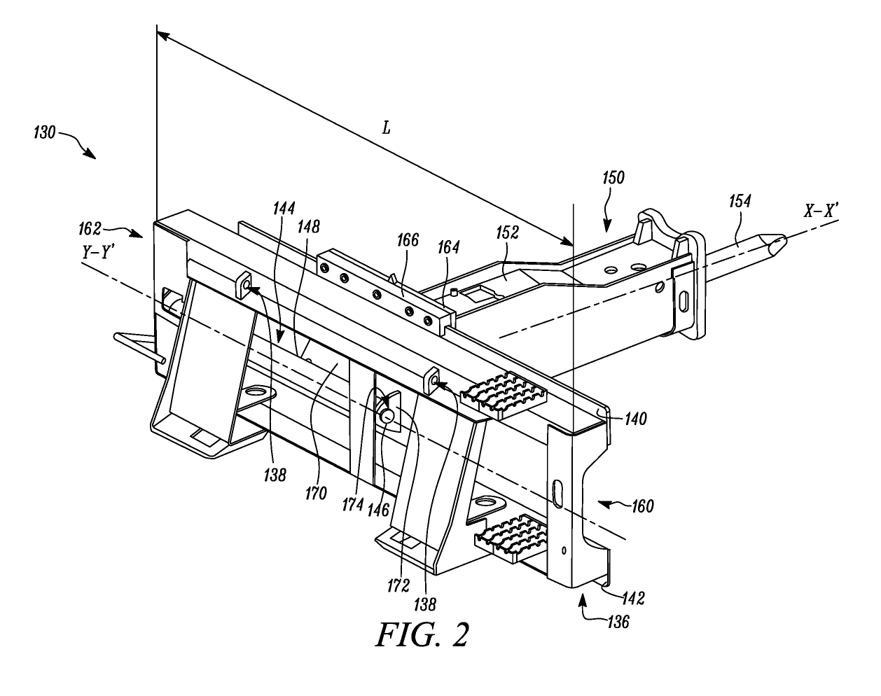

The hammer attachment 130 illustrated herein is embodied as a hydraulic hammer attachment 130, without limiting the scope of the present disclosure. The hammer attachment 130 includes a frame member 136. The frame member 136 is coupled to the linkage assembly 116. As shown in FIG. 2, a rear end 108 of the frame member 136 includes a pair of apertures 138. The apertures 138 in the frame member 136 may be aligned with apertures (not shown) at a front end of the link arms 120, 122 (see FIG. 1) to receive mechanical fasteners (not shown) for fixedly attaching the frame member 136 with the link arms 120, 122.

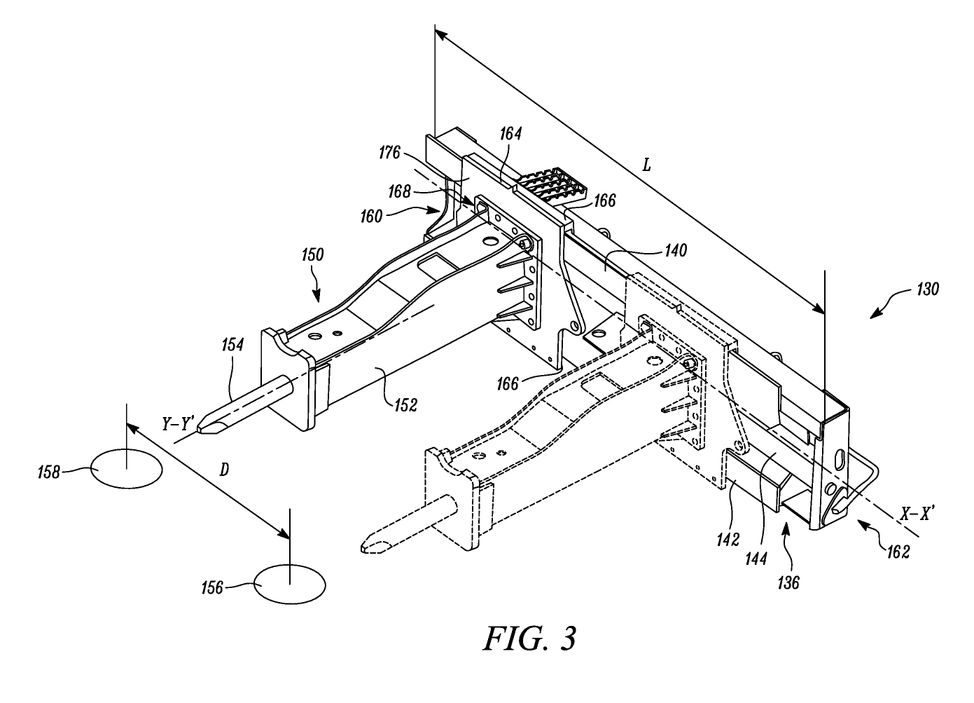

Referring now to FIGS. 2 and 3, the frame member 136 includes a length “L” defined along a first axis X-X′. The frame member 136 also includes a pair of rails 140, 142 extending along more than half of the total length “L” of the frame member 136. Further, the frame member 136 supports a linear actuator 144 that can be controlled by the operator seated in the operator cab 104 based on operational requirements. The linear actuator 144 includes a piston 146 (shown in FIG. 2) and a cylinder 148 (shown in FIG. 2). The linear actuator 144 may embody a hydraulic cylinder and may be operated by the hydraulic system of the machine 100, without any limitations. Alternatively, the linear actuator 144 may include a pneumatic cylinder. The frame member 136 is generally made of a sturdy material that can withstand high stresses during the hammering operations that is performed by the hammer attachment 130. In one example, the frame member 136 is made of a metal, without any limitations.

The hammer attachment 130 also includes a reciprocating hammer 150. The hammer 150 disclosed herein may include any known in the art hammer tool that can perform the hammering operation. Referring to FIG. 3, the hammer 150 is slidably coupled to the frame member 136 such that the hammer 150 is movable along the length “L” of the frame member 136. Thus, the movement of the hammer 150 causes a position of the hammer 150 to change relative to the chassis 102. Further, the movement of the hammer 150 is independent of a movement of the machine 100.

For example, when the hammer 150 concludes a first hammering operation at a first target location 156, the hammer 150 is movable along the length “L” of the frame member 136 to perform a second hammering operation at a second target location 158. In such an example, the hammer 150 moves by a sliding distance “D” along the length “L” of the frame member 136. The sliding distance “D” referred to herein is defined by a relative distance between the first target location 156 and the second target location 158.

The hammer 150 includes a body 152 to which a breaking tool 154 is attached. The breaking tool 154 of the hammer 150 reciprocates with respect to the body 152, along a second axis Y-Y′. The second axis Y-Y′ is different from the first axis X-X′ along which the length “L” of the frame member 136 is defined. In some examples, the first axis X-X′ may be perpendicular to the second axis Y-Y′, without limiting the scope of the present disclosure. Alternatively, the second axis Y-Y′ may be inclined with respect to the first axis X-X′.

The hammer 150 is coupled to a plate 164. More particularly, the plate 164 defines a first surface 176 and the hammer 150 is coupled to the first surface 176 using mechanical fasteners 168. The mechanical fasteners 168 may include bolt, screw, rivet, pins, and the like, without any limitations. In another example, the hammer 150 may be coupled to the first surface 176 by welding, brazing, soldering, and the like. Further, the plate 164 also includes a pair of sliding brackets 166. Each of the sliding brackets 166 defines a passageway that receives the rails 140, 142 of the frame member 136 when the hammer 150 moves along the rails 140, 142.

The plate 164 also includes a second surface 170 (shown in FIG. 2). A bracket 172 (shown in FIG. 2) is coupled to the second surface 170 of the plate 164. An aperture 174 (shown in FIG. 2) is defined in the bracket 172. The aperture 174 is fixedly coupled with an end of the piston 146 of the linear actuator 144 such that a movement of the piston 146 causes the hammer 150 to slide along the length “L” of the frame member 136. The plate 164 includes an opening (not shown). The opening allows coupling of hydraulic and/or electric lines with the hammer 150. The plate 164 may be made of any material having high structural stability, such as a metal or a combination of metals. In some examples, the plate 164 and the frame member 136 may be made of the same material.

As disclosed earlier, the hammer 150 is movable along the rails 140, 142 between either ends 160, 162 of the frame member 136. The operator seated in the operator cab 104 may control one of the input devices present in the operator cab 104 to generate a command for changing the position of the hammer 150. This command can be translated to the change in the position of the hammer 150 by the hydraulic system, an electromechanical system, or the pneumatic system associated with the machine 100. More particularly, the hydraulic system, the electromechanical system, or the pneumatic system may trigger an extension of the piston 146 (see FIG. 2) of the linear actuator 144, based on the operator command. The extension of the piston 146 causes the hammer 150 to move towards the end 160 of the frame member 136. Alternatively, the hydraulic system, the electromechanical system, or the pneumatic system may trigger a retraction of the piston 146, based on the operator command. The retraction of the piston 146 causes the hammer 150 to move towards the end 162 of the frame member 136.

In another example, the movement of the hammer 150 can be manually controlled by the operator seated in the operator cab 104 by changing a position of a lever or a stick present in the operator cab 104. Thus, the movement of the hammer 150 can be controlled manually and/or by the hydraulic system, the electromechanical system, or the pneumatic system of the machine 100, without any limitations.

### INDUSTRIAL APPLICABILITY

The present disclosure relates to the hammer attachment 130 associated with the machine 100. The components of the hammer attachment 130 are simple to design and manufacture, and are cost effective. Also, the machine 100 does not require any design modifications to incorporate the hammer attachment 130; hence the hammer attachment 130 can be easily retrofitted to an existing machine. The hammer attachment 130 reduces time required to perform hammering operations at different locations, as the movable hammer attachment 130 eliminates requirement of the movement and repositioning of the entire machine. Further, the hammer attachment 130 disclosed herein improves accuracy and efficiency of the hammering operations performed by the machine 100 that is coupled with the hammer attachment 130.

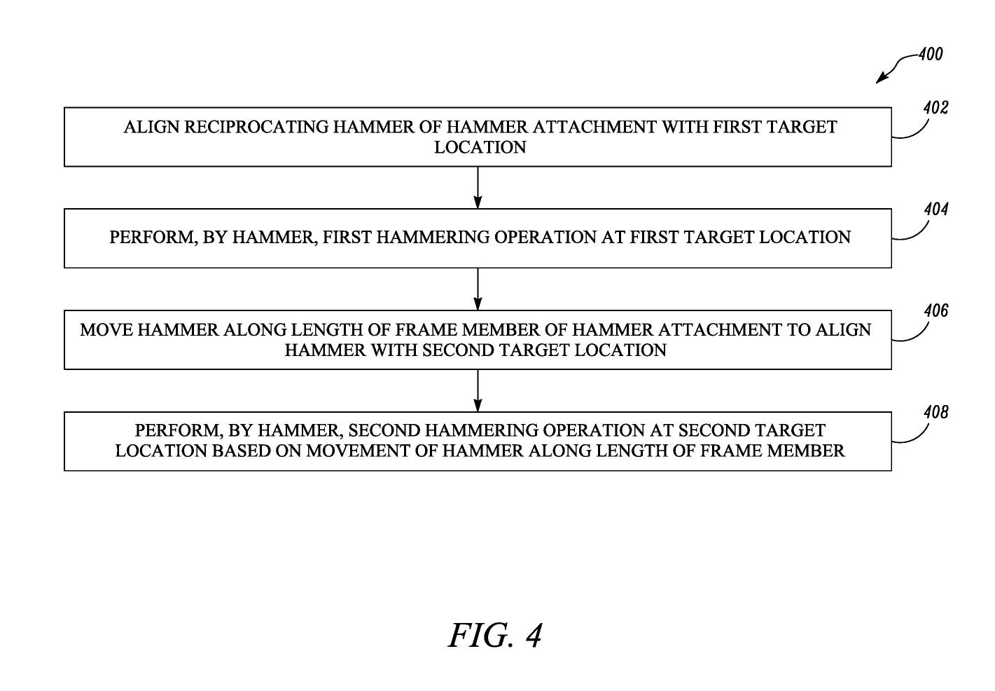

FIG. 4 illustrates a method 400 of operating the hammer attachment 130 associated with the machine 100. At step 402, the reciprocating hammer 150 of the hammer attachment 130 is aligned with the first target location 156. At step 404, the first hammering operation is performed by the hammer 150 at the first target location 156. At step 406, the hammer 150 is moved along the length “L” of the frame member 136 of the hammer attachment 130 to align the hammer 150 with the second target location 158. The frame member 136 is fixedly attached to the machine 100. Also, the length “L” of the frame member 136 is defined along the first axis X-X′ and is different from the second axis Y-Y′ of the reciprocating movement of the hammer 150.

Further, the movement of the hammer 150 causes the position of the hammer 150 to change relative to the chassis 102 of the machine 100 and the movement of the hammer 150 is independent of the movement of the machine 100. In one example, the movement of the hammer 150 can be controlled by at least one of the hydraulic system, the electromechanical system, and the pneumatic system of the machine 100 based on the operator command. In another example, the movement of the hammer 150 can be manually controlled by the operator of the machine 100.

At step 408, the second hammering operation is performed at the second target location 158 based on the movement of the hammer 150 along the length “L” of the frame member 136. It should be noted that the hammer 150 moves by a sliding distance “D” along the length “L” of the frame member 136. The sliding distance “D” is defined by the relative distance between the first target location 156 and the second target location 158.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A hammer attachment for a machine comprising:
a frame member configured to couple to the machine; and
a reciprocating hammer slidably coupled to the frame member such that the hammer is movable along a length of the frame member, the length of the frame member being in a different axis from an axis of reciprocating movement of the hammer.

2. The hammer attachment of claim 1, wherein the movement of the hammer is controlled by at least one of a hydraulic system and an electromechanical system based on operator command.

3. The hammer attachment of claim 1, wherein the movement of the hammer is manually controlled by an operator of the machine.

4. The hammer attachment of claim 1, wherein the hammer attachment is coupled to a linkage assembly of the machine.

5. The hammer attachment of claim 1, wherein the movement of the hammer causes a position of the hammer to change relative to a chassis of the machine independent of a movement of the machine.

6. The hammer attachment of claim 1, wherein the hammer is adapted to move along rails of the frame member.

7. The hammer attachment of claim 1, wherein the hammer attachment is a hydraulic hammer attachment coupled at a front end of the machine.

8. A machine comprising:
a chassis;
a linkage assembly; and
a hammer attachment configured to couple to the linkage assembly, the hammer attachment comprising:
a frame member; and
a reciprocating hammer slidably coupled to the frame member such that the hammer is movable along a length of the frame member, the length of the frame member being in a different axis from an axis of reciprocating movement of the hammer.

9. The machine of claim 8, wherein the movement of the hammer is controlled by at least one of a hydraulic system and an electromechanical system based on operator command.

10. The machine of claim 8, wherein the movement of the hammer is manually controlled by an operator of the machine.

11. The machine of claim 8, wherein the hammer attachment is coupled at a front end of the machine.

12. The machine of claim 8, wherein the movement of the hammer causes a position of the hammer to change relative to the chassis of the machine independent of a movement of the machine.

13. The machine of claim 8, wherein the hammer is adapted to move along rails of the frame member.

14. The machine of claim 8, wherein the hammer attachment is a hydraulic hammer attachment.

15. A method of operating a hammer attachment for a machine, the method comprising:
aligning a reciprocating hammer of the hammer attachment with a first target location;
performing, by the hammer, a first hammering operation at the first target location;
moving the hammer along a length of a frame member of the hammer attachment to align the hammer with a second target location, the length of the frame member being in a different axis from an axis of reciprocating movement of the hammer; and
performing, by the hammer, a second hammering operation at the second target location based on the movement of the hammer along the length of the frame member.

16. The method of claim 15, wherein the movement of the hammer causes a position of the hammer to change relative to a chassis of the machine independent of a movement of the machine.

17. The method of claim 15, wherein the movement of the hammer by a sliding distance along the length of the frame member is defined by a relative distance between the first target location and the second target location.

18. The method of claim 15 further including fixedly attaching the frame member to the machine.

19. The method of claim 15, wherein the movement of the hammer is controlled by at least one of a hydraulic system and an electromechanical system based on operator command.

20. The method of claim 15, wherein the movement of the hammer is manually controlled by an operator of the machine.
